(19) United States
(12) Patent Application Publication
(10) Pub. No.: US 2010/0027503 A1
(43) Pub. Date: Feb. 4, 2010

(54) METHOD AND APPARATUS FOR REDUCING DATA LOSS DURING HANDOVER IN A WIRELESS COMMUNICATION SYSTEM

(75) Inventors: Srinivasa Rao Eravelli, San Diego, CA (US); Hailiang Cai, San Diego, CA (US); Yun Lin, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/183,741

(22) Filed: Jul. 31, 2008

(51) Int. Cl. H04Q 7/00

(52) U.S. Cl. 370/331

(57) ABSTRACT

Techniques for buffering and resending data in order to reduce data loss during handover are described. A network controller may determine whether or not to buffer data for a user equipment (UE). The network controller may continuously buffer a predetermined amount of latest data sent to a serving Node B if a decision is made to buffer the data for the UE. In one design, the network controller may send data for the UE to a source Node B, perform handover of the UE from the source Node B to a target Node B, resend to the target Node B a portion of the data sent previously to the source Node B, and send new data for the UE to the target Node B. e.g., after the resent data. The buffer and resend feature may be selectively enabled or disabled for each data flow for the UE.

### BACKGROUND

I. Field

The present disclosure relates generally to communication, and more specifically to techniques for sending and receiving data in a wireless communication system.

II. Background

Wireless communication systems are widely deployed to provide various communication services such as voice, video, packet data, messaging, broadcast, etc. These systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include a number of Node Bs, and each Node B may provide communication coverage for a particular geographic area. A user equipment (UE) may receive data from one Node B at any given moment. The UE may be mobile and may move out of the coverage of a first Node B and into the coverage of a second Node B. The UE may perform handover from the first Node B to the second Node B. The handover may entail exchanging signaling messages between various entities and may take some amount of time to complete. During the handover, some data may be lost if (i) one Node B sends data to the UE while the UE monitors another Node B or (ii) the UE decodes the data in error due to poor channel conditions. It may be desirable to reduce data loss during handover.

### SUMMARY

Techniques for buffering and resending data in order to reduce data loss during handover are described herein. In an aspect, a network controller may determine whether or not to buffer data for a UE. The network controller may continuously buffer a predetermined amount of latest data sent to a serving Node B for the UE if a decision is made to buffer the data for the UE.

In one design, the network controller may send data for the UE to a source Node B, perform handover of the UE from the source Node B to a target Node B, and resend to the target Node B a portion of the data sent previously to the source Node B. The resent data may include a predetermined amount of the latest data (e.g., a predetermined number of latest packets) sent previously to the source Node B. The network entity may send new data for the UE to the target Node B. e.g., after the resent data. The new data may comprise data not sent to the source Node B.

In one design, the network controller may maintain at least one data flow for the UE and may determine whether or not to buffer each data flow. The network controller may select each data flow carrying real-time data for buffering and/or may select data flows for buffering based on other criteria. The network controller may continuously buffer a predetermined amount of latest data for each data flow selected for buffering. The network controller may resend to the target Node B a portion of data for each data flow selected for buffering at handover of the UE.

In one design, the UE may receive data from the source Node B, perform handover from the source Node B to the target Node B, and receive resent data and new data from the target Node B. The UE may detect for duplicate data received from both the source and target Node Bs and may retain a single copy of the duplicate data.

Various aspects and features of the disclosure are described in further detail below.

### BRIEF DESCRIPTION OF THE DRAWINGS

FIG. 1 shows a wireless communication system.

FIG. 2 shows protocol stacks at a UE, a serving Node B, and an RNC.

FIG. 3 shows a message flow for a call with inter-Node B handover.

FIG. 4 shows a message flow for a call with inter-Node B handover and a “buffer and resend” feature.

FIG. 5 shows a design of the buffer and resend feature for each MAC-d flow.

FIG. 6 shows a circular buffer implementing the buffer and resend feature.

FIG. 7 shows a process for sending data by an RNC.

FIG. 8 shows a process for sending data by a target Node B.

FIG. 9 shows a process for receiving data by a UE.

FIG. 10 shows a block diagram of the UE, two Node Bs, and the RNC.

### DETAILED DESCRIPTION

The buffer and resend techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), Flash-OFDM®, etc. UTRA and E-UTRA are part of Universal Mobile Telecommunication System (UMTS). 3GPP Long Term Evolution (LTE) is an upcoming release of UMTS that uses E-UTRA. UTRA, E-UTRA, UMTS, LTE and GSM are described in documents from an organization named “3rd Generation Partnership Project” (3GPP). cdma2000 and UMB are described in documents from an organization named “3rd Generation Partnership Project 2” (3GPP2). For clarity, certain aspects of the techniques are described below for WCDMA, and 3GPP terminology is used in much of the description below.

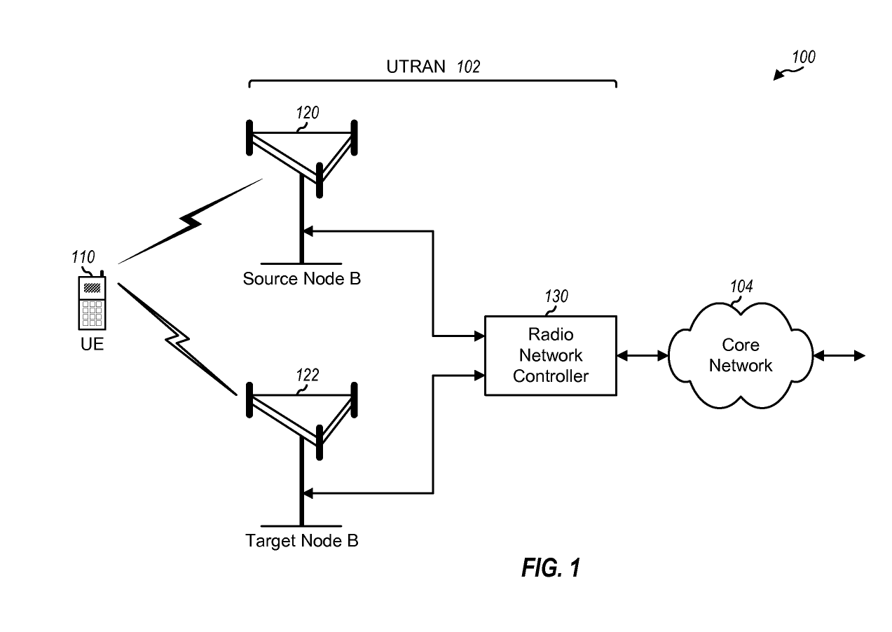

FIG. 1 shows a wireless communication system 100, which includes a Universal Terrestrial Radio Access Network (UTRAN) 102 and a core network 104. UTRAN 102 may include any number of Node Bs and other network entities. For simplicity, only two Node Bs 120 and 122 and one Radio Network Controller (RNC) 130 are shown in FIG. 1 for UTRAN 102. A Node B is a fixed station that communicates with the UEs and may also be referred to as an evolved Node B (eNode B), a base station, an access point, etc. Each Node B provides communication coverage for a particular geographic area. The coverage area of a Node B may be partitioned into multiple (e.g., three) smaller areas. Each smaller area may be served by a respective Node B subsystem. In 3GPP, the term “cell” can refer to the smallest coverage area of a Node B and/or a Node B subsystem serving this coverage area.

RNC 130 couples to Node Bs 120 and 122 and provides coordination and control for these Node Bs. RNC 130 may also communicate with network entities within core network 104. Core network 104 may include various network entities that support various functions and services for the UEs.

A UE 110 may communicate with Node B 120 and/or Node B 122 via the downlink and uplink. The downlink (or forward link) refers to the communication link from a Node B to a UE, and the uplink (or reverse link) refers to the communication link from the UE to the Node B. For the downlink, UE 110 may receive data from only one Node B at any given moment. For the uplink, UE 110 may send data to one or more Node Bs. Much of the description below is for data transmission on the downlink, and UE 110 may be assumed to be communicating with only one Node B at any given moment. UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, etc.

3GPP Release 5 and later supports High-Speed Downlink Packet Access (HSDPA), which is a set of channels and procedures that enables high-speed packet data transmission on the downlink. For HSDPA, a Node B may send data on a High Speed Downlink Shared Channel (HS-DSCH), which is a downlink transport channel that is shared by all UEs in both time and code. The HS-DSCH may carry data for one or more UEs in each transmission time interval (TTI). In WCDMA, a 10 millisecond (ms) radio frame is partitioned into five 2-ms subframes, each subframe includes three slots, and each slot has a duration of 0.667 ms. For HSDPA, a TTI is equal to one subframe and is the smallest unit of time in which a UE might be scheduled and served. The sharing of the HS-DSCH may change dynamically from TTI to TTI. A Node B may send control information on a Shared Control Channel for HS-DSCH (HS-SCCH). The control information may identify each UE being served in each TTI and may also provide parameters (e.g., coding and modulation) used by the scheduled UEs to receive their data from the HS-DSCH.

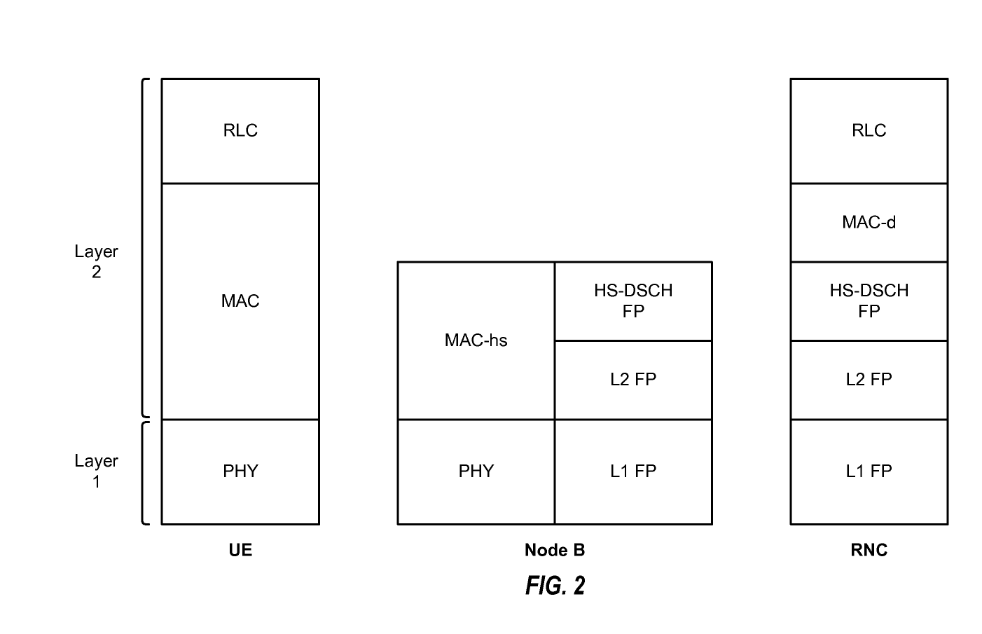

FIG. 2 shows example protocol stacks at UE 110, a serving Node B, and RNC 130 for HSDPA. The serving Node B may be Node B 120 or 122 in FIG. 1. For simplicity, FIG. 2 shows the protocol stacks for only a data link layer (Layer 2) and a physical layer (Layer 1).

The protocol stack for UE 110 may include Radio Link Control (RLC) and Medium Access Control (MAC) for Layer 2 and an air-link interface (e.g., WCDMA) for Layer 1. RLC may provide reliability for data transmission and may perform automatic retransmission (ARQ) of data and duplicate detection. In RLC, data may be processed as belonging to logical channels. MAC may perform a number of functions such as mapping and/or multiplexing logical channels to transport channels. The physical layer (PHY) may provide a mechanism for transmitting data from MAC. The physical layer may perform a number of functions such as (i) mapping transport channels to physical channels, (ii) processing (e.g., coding, interleaving, and rate matching) of data for each transport channel, (iii) processing (e.g., spreading and scrambling) of data for each physical channel, and (iv) power control of each set of physical channels.

On the network side, RLC may be terminated at RNC 130. MAC may be partitioned into MAC-d and MAC-hs. MAC-d may perform multiplexing of logical channels from RLC to MAC-d flows. MAC-hs may perform a number of functions such as flow control, scheduling and priority handling, hybrid automatic repeat request (HARQ) transmission, and transport format combination indicator (TFRI) selection. MAC-d may terminate at RNC 130 whereas MAC-hs may terminate at the serving Node B. The air-link interface may terminate at the serving Node B. The serving Node B may communicate with RNC 130 via HS-DSCH FP (frame protocol) over Layer 2 and Layer 1. The various protocols for HSDPA are described in 3GPP TS 25.308, entitled “High Speed Downlink Packet Access (HSDPA); Overall description; Stage 2,” which is publicly available.

Referring back to FIG. 1, UE 110 may initially communicate with Node B 120 on the downlink. UE 110 may be mobile and may be handed over from Node B 120 to Node B 122. For the handover, Node B 120 may be referred to as a source Node B, and Node B 122 may be referred to as a target Node B. After the handover, UE 110 may communicate with Node B 122. Node B 120 may be a serving Node B for UE 110 prior to the handover, and Node B 122 may be the serving Node B after the handover.

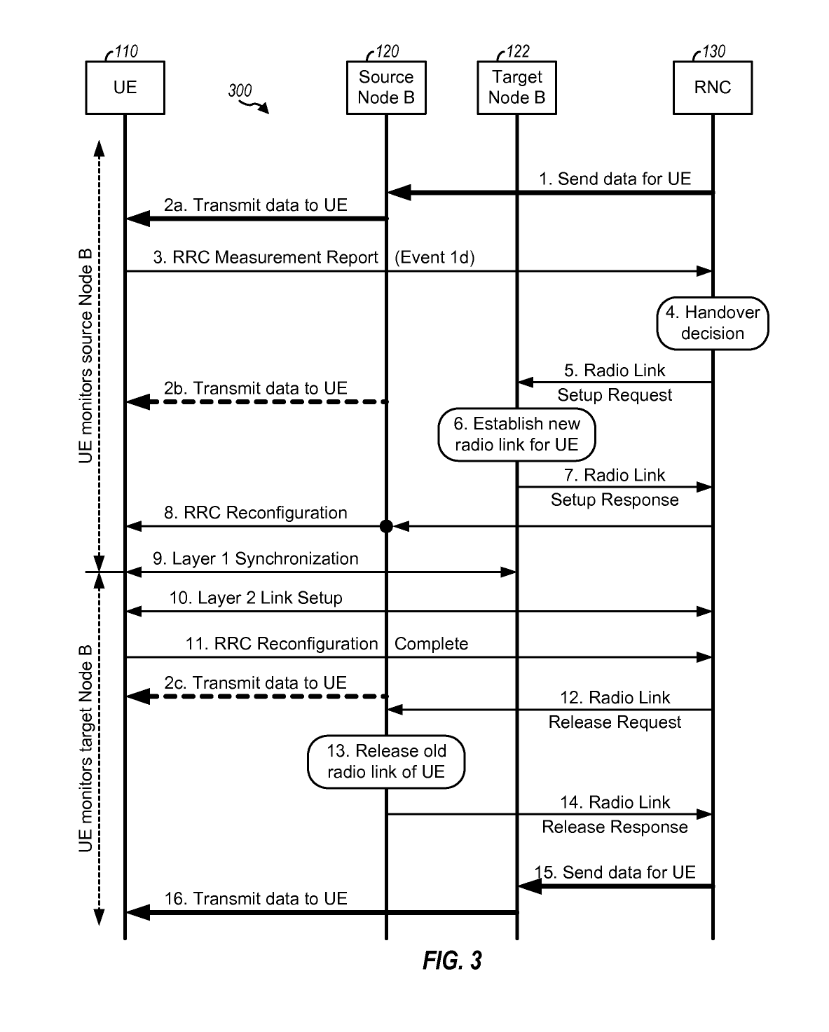

FIG. 3 shows an example message flow 300 for a call with inter-Node B handover in WCDMA. For simplicity, FIG. 3 shows only data transmission on the downlink and omits data transmission on the uplink.

UE 110 may initially establish a call, which may be for Voice-over-Internet Protocol (VoIP), packet data, etc. For the downlink, RNC 130 may send data for UE 110 to source Node B 120 (step 1). Source Node B 120 may transmit the data on the HS-DSCH to UE 110 (step 2a). UE 110 may periodically measure the signal strength of different cells. UE 110 may determine that the signal strength of source Node B 120 is sufficiently low and that the signal strength of target Node B 122 is sufficiently high. UE 110 may then send a Radio Resource Control (RRC) Measurement Report message for an Event Id to indicate the detected condition (step 3). UE 110 may send this RRC message to source Node B 120 and/or target Node B 122, which may forward the RRC message to RNC 130.

RNC 130 may receive the RRC Measurement Report message from UE 110 and may make a decision to handover UE 110 to target Node B 122 (step 4). RNC 130 may then send a Radio Link Setup Request message to target Node B 122 to request setup of a new radio link for UE 110 (step 5). Target Node B 122 may set up the new radio link for UE 110 (step 6), begin transmission and reception on the new radio link, and return a Radio Link Setup Response message to RNC 130 (step 7).

RNC 130 may send an RRC Reconfiguration message via source Node B 120 to UE 110 (step 8). This RRC Reconfiguration message may be a Physical Channel Reconfiguration message, a Radio Bearer Reconfiguration message, a Transport Channel Reconfiguration message, a Cell Update Confirm message, some other message, or some other mechanism. The RRC Reconfiguration message may indicate the radio resources to use for the new radio link.

Upon receiving the RRC Reconfiguration message, UE 110 may terminate reception of the old radio link from source Node B 120. UE 110 may perform Layer 1 synchronization with target Node B 122 (step 9) and may establish Layer 2 link with RNC 130 (step 10). UE 110 may then send an RRC Reconfiguration Complete message to RNC 130 (step 11). This RRC Reconfiguration Complete message may be a Physical Channel Reconfiguration Complete message, a Radio Bearer Reconfiguration Complete message, a Transport Channel Reconfiguration Complete message, some other message, or some other mechanism.

Upon receiving the RRC Reconfiguration Complete message, RNC 130 may send a Radio Link Release Request message to source Node B 120 (step 12). Source Node B 120 may release the old radio link for UE 110 (step 13) and may return a Radio Link Release Response message to RNC 130 (step 14).

After step 9, UE 110 may periodically estimate the downlink channel quality for target Node B 122, generate channel quality indicator (CQI) information, and send the CQI information to the target Node B. UE 110 may also start monitoring the HS-SCCH from target Node B 122 for control information for possible data transmission on the HS-DSCH to the UE. After step 11, RNC 130 may send data for UE 110 to target Node B 120 (step 15). Target Node B 120 may transmit the data on the HS-DSCH to UE 110 (step 16).

FIG. 3 shows an example message flow for inter-Node B handover in WCDMA. Handover may also be performed based on other message flows, which may utilize different sequences of messages. Handover in WCDMA is described in 3GPP TS 25.331, entitled “Radio Resource Control (RRC); Protocol Specification,” and in 3GPP TS 25.303, entitled “Interlayer procedures in Connected Mode,” both of which are publicly available.

For HSDPA, only one serving Node B transmits data on the downlink to a UE at any given moment. During handover, the UE and the UTRAN may communicate with each other to determine which Node B will serve the UE. As shown in FIG. 3, UE 110 may monitor source Node B 120 and receive data from this Node B up to step 9. UE 110 may switch to target Node B 122 at step 9 and may monitor this Node B from this point forward.

Some data for UE 110 may be lost during handover due to several reasons. First, source Node B 120 may continue to transmit data to UE 110 (e.g., step 2c in FIG. 3) after the UE has switched to target Node B 122. UE 110 would not receive this data from source Node B 120. Second, the channel conditions for source Node B 120 may have deteriorated, and some data sent by this Node B (e.g., step 2b in FIG. 3) prior to step 9 may be received in error by UE 110. Third, source Node B 120 may have a buffer of data to send to UE 110 and may not have the opportunity to transmit this data to the UE prior to step 9. This data may not be forwarded from source Node B 120 to target Node B 122 and may be lost as a result of the handover. UE 110 may observe an outage of data on the downlink, which may run into hundreds of milliseconds during handover. This data outage may be detrimental for real-time applications such as VoIP and may result in noticeable degradation in voice quality.

In an aspect, data loss during handover may be reduced by resending to the target Node B some data that was sent previously to the source Node B. The target Node B may send this resent data, e.g., before any new data, to the UE. The UE may receive duplicate data from both the source and target Node Bs and may simply discard duplicate copy of the data. By resending some data from the target Node B during handover, data loss at the UE during handover may be reduced, and performance degradation may be avoided.

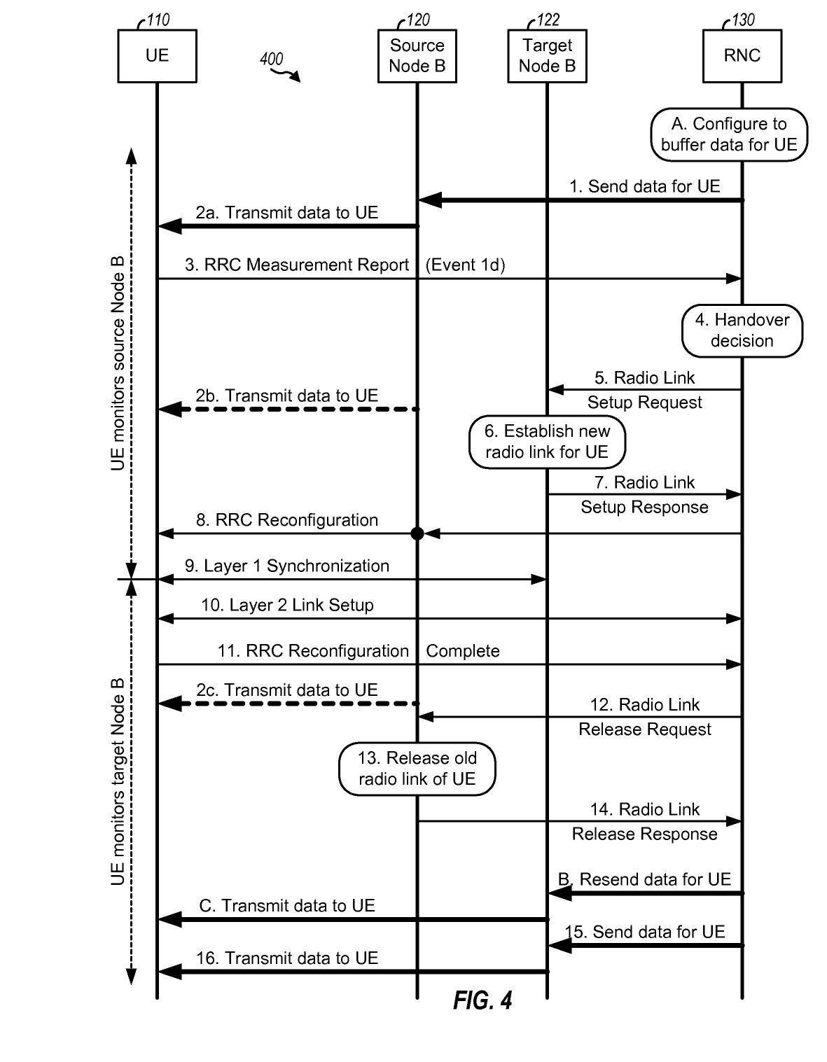

FIG. 4 shows a design of a message flow 400 for a call with inter-Node B handover and the buffer and resend feature. UE 110 may initially establish a call, e.g., for VoIP. RNC 130 may configure to buffer certain amount of latest data for UE, as described below (step A). This data buffering may be configured at call setup and/or at a later time during the all. RNC 130 may send data for UE 110 to source Node B 120 (step 1), which may transmit the data on the HS-DSCH to UE 110 (step 2a).

UE 110 may periodically measure the signal strength of different cells. Upon detecting sufficiently low signal strength for source Node B 120 and sufficiently high signal strength for target Node B 122, UE 110 may send an RRC Measurement Report message for an Event Id to RNC 130 (step 3). RNC 130 may make a decision to handover UE 110 to target Node B 122 (step 4) and may send a Radio Link Setup Request message to target Node B 122 (step 5). Target Node B 122 may set up the new radio link for UE 110 (step 6) and may return a Radio Link Setup Response message to RNC 130 (step 7).

RNC 130 may send an RRC Reconfiguration message via source Node B 120 to UE 110 (step 8). Upon receiving this message, UE 110 may perform Layer 1 synchronization with target Node B 122 (step 9) and may establish Layer 2 link with RNC 130 (step 10). UE 110 may then send an RRC Reconfiguration Complete message to RNC 130 (step 11). RNC 130 may send a Radio Link Release Request message to source Node B 120 (step 12). Source Node B 120 may release the old radio link for UE 110 (step 13) and may return a Radio Link Release Response message to RNC 130 (step 14).

After step 11, RNC 130 may resend to target Node B 122 some data that was sent previously to source Node B 120 (step B). Target Node B 120 may transmit this data on the HS-DSCH to UE 110 (step C). RNC 130 may also send new data for UE 110 to target Node B 122 (step 15). Target Node B 120 may transmit the new data on the HS-DSCH to UE 110 (step 16).

In the design shown in FIG. 4, RNC 130 may buffer a predetermined amount of the latest data sent to source Node B 120. RNC 130 may perform this data buffering continuously after being configured in step A. RNC 130 may stop sending data to source Node B 120 prior to sending the RRC Reconfiguration message in step 8. RNC 130 may then resend the buffered data to target Node B 122 in step B, which may occur any time after receiving the RRC Reconfiguration Complete message from UE 110 in step 11. In one design, after all of the buffered data has been resent to target Node B 122, RNC 130 may resume normal operation and send new data for UE 110 to target Node B 122 in the normal manner in step 15. RNC 130 may similarly buffer a predetermined amount of the latest data sent to target Node B 120 in anticipation of another handover for UE 110.

In the design shown in FIG. 4, RNC 130 may perform buffer and resend operation in order to reduce data loss at UE 110 during handover. Source Node B 120 and target Node B 122 may operate in the normal manner and may not be aware of RNC 130 performing the buffer and resend operation. Similarly, UE 110 may operate in the normal manner and may be minimally impacted by the buffer and resend operation performed by RNC 130. UE 110 may receive duplicate data from the source and target Node Bs. UE 110 may detect for duplicate data based on a sequence number assigned to each RLC protocol data unit (PDU) and may simply discard the duplicate data. The buffer and resend operation may thus be implemented with small impact to only RNC 130.

The buffer and resend feature may be implemented in various manners. In general, data at any layer in a protocol stack may be buffered and resent when needed. Each layer may process data as belonging to flows or channels. Data for some or all of the flows/channels at a selected layer may be buffered and resent when needed.

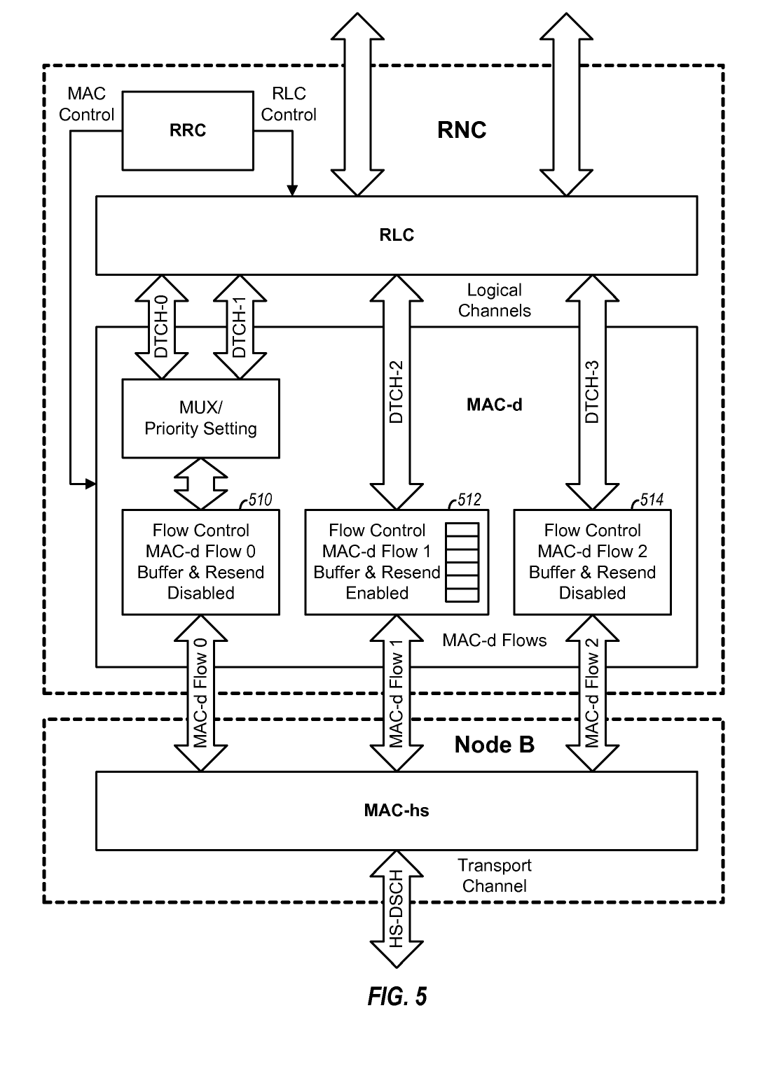

FIG. 5 shows a block diagram of a design of selectively performing buffer and resend operation for each MAC-d flow at RNC 130. At RNC 130, RLC may receive data from higher layer as RLC service data units (SDUs). RLC may perform various functions such as (i) segmentation and concatenation of RLC SDUs to form RLC PDUs, (ii) multiplexing of RLC PDUs to logical channels, and (iii) retransmission of RLC PDUs received in error by UE 110. In the example shown in FIG. 5, RLC provides RLC PDUs on four Dedicated Traffic Channels DTCH-0 through DTCH-3, which are logical channels, to MAC-d.

MAC-d may perform various functions such as mapping logical channels to MAC-d flows, multiplexing multiple logical channels onto a MAC-d flow as appropriate, ciphering, etc. In the example shown in FIG. 5, MAC-d multiplexes two logical channels DTCH-0 and DTCH-1 onto MAC-d flow 0, maps logical channel DTCH-2 onto MAC-d flow 1, maps logical channel DTCH-3 onto MAC-d flow 2, and provides three MAC-d flows to MAC-hs. In general, MAC-d may provide one or more MAC-d flows to MAC-hs, with each MAC-d flow being associated with certain scheduling attributes.

In the design shown in FIG. 5, the buffer and resend feature may be selectively enabled or disabled for each MAC-d flow. Data for each MAC-d flow may be buffered in a respective buffer and may be provided to MAC-hs whenever directed. For each MAC-d flow in which the buffer and resend feature is enabled, the data for that MAC-d flow may be retained in the buffer after the data has been sent to a serving Node B. When handover from a source Node B to a target Node B occurs, certain amount of the latest data retained in the buffer may be resent to the target Node B. e.g., before sending new data to the target Node B. Resent data is data that has been sent previously to the source Node B. New data is data that has not been sent to the source Node B. For each MAC-d flow in which the buffer and resend feature is disabled, the data for that MAC-d flow is not resent to the target Node B, and only new data for that MAC-d flow is sent to the target Node B.

In the example shown in FIG. 5, a flow control unit 510 may receive data from DTCH-0 and DTCH-1 and may provide the received data to MAC-d flow 0. A flow control unit 512 may receive data from DTCH-2 and may provide the received data to MAC-d flow 1. A flow control unit 514 may receive data from DTCH-3 and may provide the received data to MAC-d flow 2. In the example shown in FIG. 5, the buffer and resend feature is disabled for MAC-d flows 0 and 2 and is enabled for MAC-d flow 1. When handover from a source Node B to a target Node B occurs, the data from MAC-d flows 0 and 2 is not resent to the target Node B. A predetermined amount of the latest data buffered by flow control unit 512 for MAC-d flow 1 may be resent to the target Node B. e.g., prior to sending new data for this MAC-d flow to the target Node B.

In general, any number of MAC-d flows and any MAC-d flow may be enabled with the buffer and resend feature. In one design, the buffer and resend feature may be enabled for only MAC-d flows carrying real-time data such as VoIP, video teleconference, etc. In another design, the buffer and resend feature may be enabled for MAC-d flows with a particular priority level or higher.

RRC may be responsible for controlling the configuration of Layers 1 and 2. RRC may provide RLC control to direct the operation of RLC. RRC may also provide MAC control to direct the operation of MAC-d. The MAC control may indicate which MAC-d flows to enable the buffer and resend feature and which MAC-d flows to disable the buffer and resend feature. At call setup and/or whenever triggered by an event, RRC may configure MAC-d to enable the buffer and resend feature for certain MAC-d flows.

When RRC receives an RRC Reconfiguration Complete message from the UE, RRC may inform MAC-d to start resending the buffered data to the target Node B. MAC-d may then resend the buffered data for each MAC-d flow with the buffer and resend feature enabled. In one design, MAC-d may resend all buffered data for a MAC-d flow first and may then start sending new data for that MAC-d flow to the target Node B. In another design, MAC-d may resend the buffered data and the new data concurrently or in any order to the target Node B. For both designs, the buffered data and the new data may be assigned sequence numbers, and the target Node B and the UE may be able to ascertain the order of the data. MAC-d may continue to buffer the new data before sending it to the target Node B. This way, MAC-d can always have the latest data that it sent to the node B in anticipation of another handover.

In another design, the buffer and resend feature may be selectively enabled or disabled for each logical channel from RLC. The buffer and resend feature may also be selectively enabled or disabled for channels or flows in other protocols and/or in other layers.

The amount of data to buffer for each MAC-d flow or each logical channel may be selected based on various criteria such as the expected amount of data to resend during handover, buffer requirements at the RNC, etc. For example, if a VoIP call sends a packet every 20 ms, and if the portion of handover in which data loss can occur covers about 200 ms, then the latest 10 packets may be continuously buffered and resent to the target Node B when handover occurs. Since a TTI is 2 ms for HSDPA and a packet arrives every 20 ms for VoIP, the target Node B may be able to transmit all of the resent packets to the UE in a fairly short amount of time so that the UE may not notice any delays. The amount of data to buffer and resend may also be configurable.

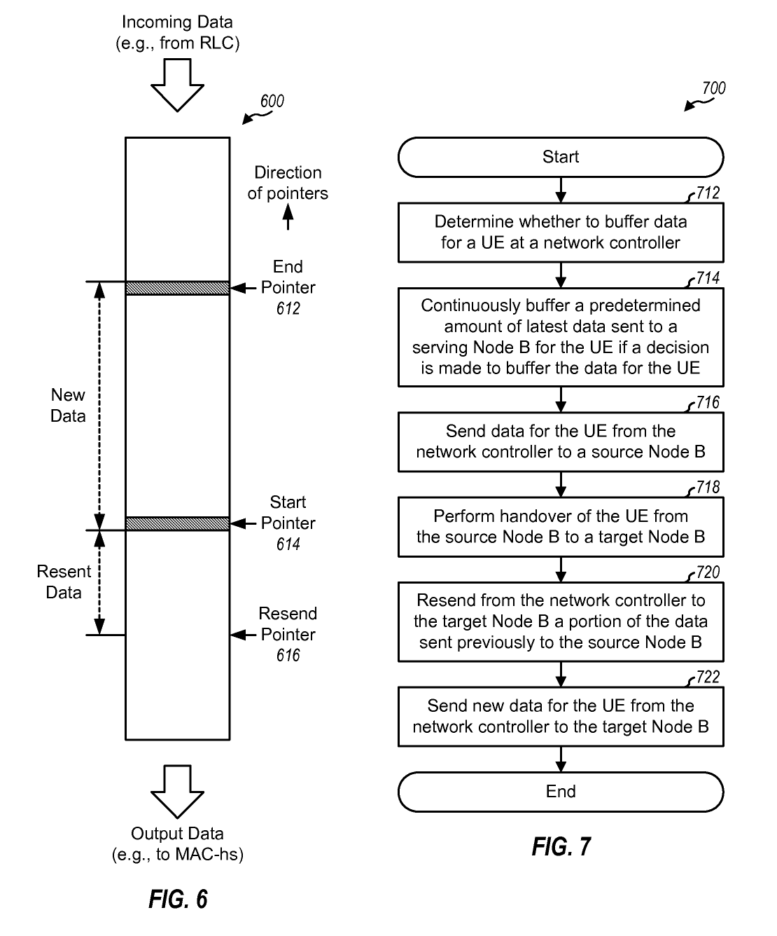

FIG. 6 shows a design of a circular buffer 600 that can implement the buffer and resend feature. Incoming data from a higher protocol (e.g., RLC) may be written to the end/back of buffer 600. Data stored in buffer 600 may be read from the start/front of the buffer and provided to a lower protocol (e.g., MAC-hs). An end pointer 612 may keep track of the end of buffer 600 and may be advanced (e.g., upward in FIG. 6) as incoming data from the higher protocol is written into the buffer. A start pointer 614 may keep track of the start of buffer 600 and may be advanced (e.g., upward in FIG. 6) as data is read from the buffer and provided to the lower protocol. A resend pointer 616 may keep track of a point in buffer 600 from which to resend data in case of handover. Pointer 616 may be a separate pointer, as shown in FIG. 6. Pointer 616 may also be implicit and defined by a predetermined offset from start pointer 614. Each pointer may wrap around to the bottom of buffer 600 after reaching the top of the buffer. The oldest data in buffer 600 may be written over with incoming data.

When handover occurs, data starting at resend pointer 616 may be provided to the target Node B. The resent data may include data between resend pointer 616 and start pointer 614. The new data may include data between start pointer 614 and end pointer 612.

FIG. 6 shows on example design of circular buffer 600 that may be used to buffer data. Data may also be buffered in other manners using other buffer structures.

FIG. 7 shows a design of a process 700 for sending data in a wireless communication system. Process 700 may be performed by a network controller, which may be an RNC or some other network entity. The network controller may determine whether to buffer data for a UE (block 712). The network controller may continuously buffer a predetermined amount of latest data sent to a serving Node B for the UE if a decision is made to buffer the data for the UE (block 714).

The network controller may send data for the UE to a source Node B (block 716). The network controller may perform handover of the UE from the source Node B to a target Node B (block 718). Block 718 may include tasks performed by RNC 130 for handover in message flow 400 shown in FIG. 4. The network entity may resend to the target Node B a portion of the data sent previously to the source Node B (block 720). The resent data may comprise a predetermined amount of the latest data (e.g., a predetermined number of latest packets) sent previously to the source Node B. The network entity may send new data for the UE to the target Node B. e.g., after or concurrent with resending the portion of the data sent previously to the source Node B (block 722). The new data may comprise data not sent to the source Node B.

In one design, the network controller may maintain at least one data flow for the UE and may determine whether or not to buffer each data flow. The network controller may select each data flow carrying real-time data for buffering. The network controller may also select data flows for buffering based on other criteria. The at least one data flow may comprise data for at least one MAC-d flow, or data for at least one logical channel, or some other data. The network controller may continuously buffer a predetermined amount of the latest data for each data flow selected for buffering. The network controller may resend to the target Node B a portion of data for each data flow selected for buffering.

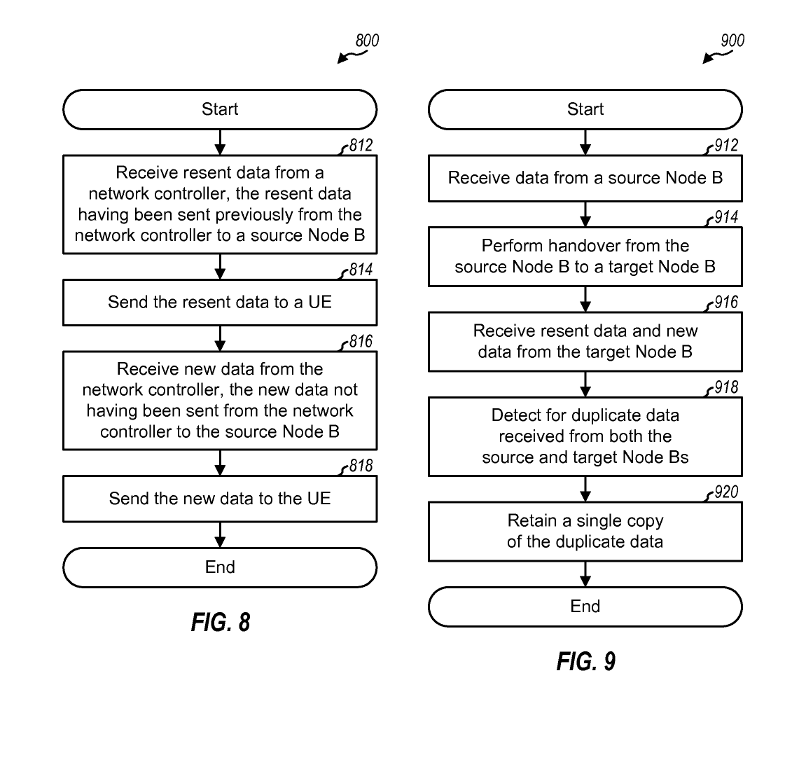

FIG. 8 shows a design of a process 800 for sending data in a wireless communication system. Process 800 may be performed by a target Node B (as described below) or by some other network entity. The target Node B may receive resent data from a network controller, with the resent data having been sent previously from the network controller to a source Node B (block 812). The target Node B may send the resent data to a UE (block 814). The target Node B may receive new data from the network controller, with the new data not having been sent from the network controller to the source Node B (block 816). The target Node B may send the new data to the UE (block 818). For blocks 814 and 818, the target Node B may send the resent data and the new data on a high speed shared channel to the UE.

FIG. 9 shows a design of a process 900 for receiving data in a wireless communication system. Process 900 may be performed by a UE (as described below) or by some other entity. The UE may receive data from a source Node B (block 912). The UE may perform handover from the source Node B to a target Node B (block 914). Block 914 may include tasks performed by UE 110 for handover in message flow 400 shown in FIG. 4. The UE may receive resent data and new data from the target Node B (block 916). The resent data may comprise data sent from a network controller to the source Node B and resent from the network controller to the target Node B. The resent data may be for a data flow selected for buffering, e.g., a data flow carrying real-time data. The new data may comprise data sent by the network controller to the target Node B but not to the source Node B. The UE may detect for duplicate data received from both the source and target Node Bs (block 918) and may retain a single copy of the duplicate data (block 920).

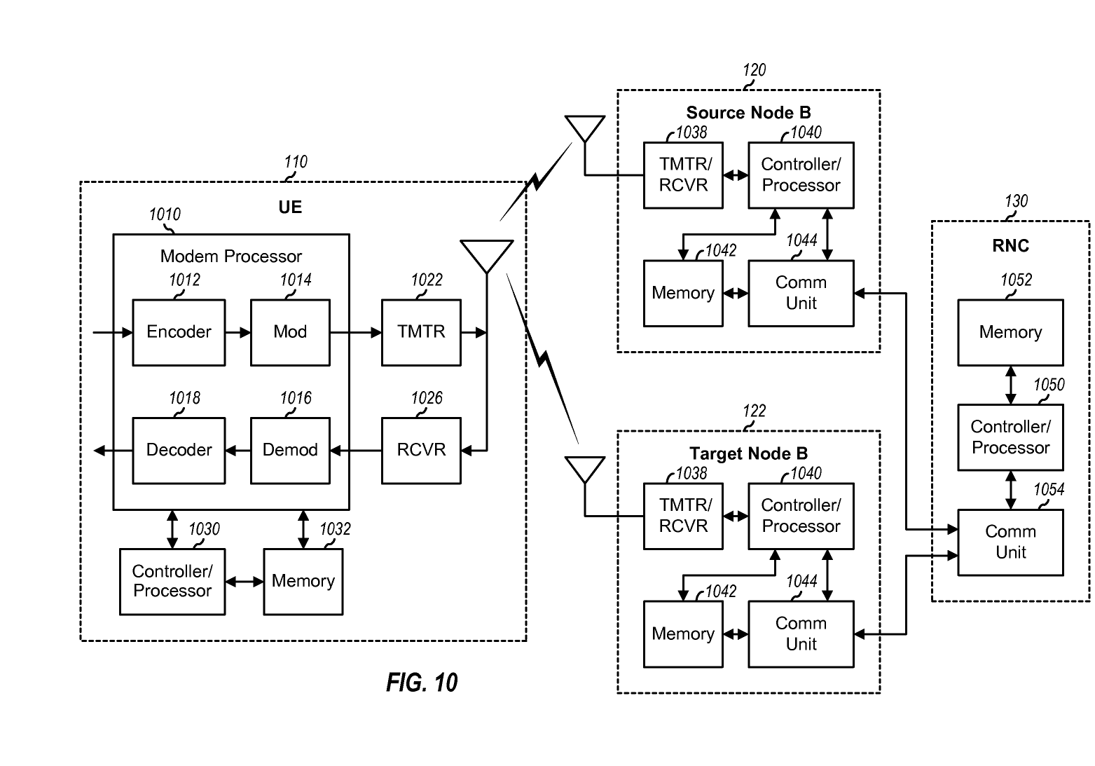

FIG. 10 shows a block diagram of a design of UE 110, Node Bs 120 and 122, and RNC 130 in FIG. 1. On the uplink, an encoder 1012 may receive traffic data and signaling messages to be sent by UE 110 on the uplink. Encoder 1012 may process (e.g., format, encode, and interleave) the traffic data and signaling messages. A modulator (Mod) 1014 may further process (e.g., modulate, channelize, and scramble) the encoded traffic data and signaling messages and provide output chips. A transmitter (TMTR) 1022 may condition (e.g., convert to analog, filter, amplify, and frequency upconvert) the output chips and generate an uplink signal, which may be transmitted to Node B 120 and/or Node B 122.

On the downlink, UE 110 may receive downlink signals transmitted by Node B 120 and/or Node B 122. A receiver (RCVR) 1026 may condition (e.g., filter, amplify, frequency downconvert, and digitize) a received signal and provide samples. A demodulator (Demod) 1016 may process (e.g., descramble, channelize, and demodulate) the samples and provide symbol estimates. A decoder 1018 may process (e.g., deinterleave and decode) the symbol estimates and provide decoded data and signaling messages sent to UE 110. Encoder 1012, modulator 1014, demodulator 1016, and decoder 1018 may be implemented by a modem processor 1010. These units may perform processing in accordance with the radio technology (e.g., WCDMA, cdma2000, etc.) used by the system. A controller/processor 1030 may direct the operation of various units at UE 110. Controller/processor 1030 may also perform or direct process 900 in FIG. 9 and/or other processes for the techniques described herein. Memory 1032 may store program codes and data for UE 110.

At each Node B, a transmitter/receiver 1038 may support radio communication with UE 110 and other UEs. A controller/processor 1040 may perform various functions for communication with the UEs. For the uplink, the uplink signal from UE 110 may be received and conditioned by receiver 1038 and further processed by controller/processor 1040 to recover the traffic data and signaling messages sent by the UE. For the downlink, traffic data and signaling messages may be processed by controller/processor 1040 and conditioned by transmitter 1038 to generate a downlink signal, which may be transmitted to UE 110 and other UEs. Controller/processor 1040 at target Node B 122 may also perform, direct or participate in process 800 in FIG. 8 and/or other processes for the techniques described herein. Memory 1042 may store program codes and data for the Node B. A communication (Comm) unit 1044 may support communication with RNC 130 and/or other network entities.

At RNC 130, a controller/processor 1050 may perform various functions to support communication services for the UEs. Controller/processor 1050 may perform processing for RRC, RLC and MAC-d shown in FIG. 5. Controller/processor 1050 may also perform, direct or participate in process 700 in FIG. 7 and/or other processes for the techniques described herein. Memory 1052 may store program codes and data for RNC 130. Memory 1052 may implement circular buffer 600 in FIG. 6 for each data flow (e.g., MAC-d flow) selected for buffering. A communication unit 1054 may support communication with the Node Bs and other network entities.

The buffer and resend techniques described herein may be used for any change in serving cell such as synchronized and unsynchronized serving cell changes. The techniques described herein may be advantageously used for an unsynchronized change in serving cell. For an unsynchronized serving cell change, a UE may switch to a target Node B based on a first trigger (e.g., reception of the RRC Reconfiguration message in step 8 in FIG. 4), and the UTRAN may switch to the target Node B based on a second trigger that may be different from the first trigger. Some data may be lost due to different switching times for the UE and the UTRAN. Furthermore, some data already sent to the source Node B and not yet sent to the UE may also be lost. The techniques described herein may reduce data loss due to these two reasons.

The buffer and resend techniques may provide certain advantages. The techniques may allow a network entity such as an RNC to continuously buffer a predetermined amount of the latest data sent to a serving Node B. No trigger is needed to start buffering the data. A trigger to start resending the buffered data to a target Node B may result from handover or some other event. Only a small amount of data may be resent to the target Node B. This may save backhaul bandwidth over bi-casting and multi-casting schemes that send data to all Node Bs in an active set of a UE when triggered, e.g., by the RRC Measurement Report message in step 3 in FIG. 4. Furthermore, data sent to the source Node B prior to this trigger may be lost with the bi-casting and multi-casting schemes whereas the buffer and resend techniques described herein may be able to avoid this data loss. The techniques described herein may also be referred to as a retro-casting scheme.

The buffer and resend techniques may be much more efficient in terms of saving backhaul costs and reducing complexity. The techniques may be implemented using existing interface between the RNC and Node Bs. The RNC may buffer data at MAC-d and may resend the data to the target Node B when there is a change in serving cell. In this case, there may be no behavior change at the Node B. The techniques may thus be readily implemented at the RNC without requiring changes to existing Node Bs.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. A method of sending data in a wireless communication system, comprising:
sending data for a user equipment (UE) from a network controller to a source Node B;
performing handover of the UE from the source Node B to a target Node B; and
resending from the network controller to the target Node B a portion of the data sent previously to the source Node B.

2. The method of claim 1, wherein the portion of the data resent to the target Node B comprises a predetermined amount of latest data sent previously to the source Node B.

3. The method of claim 1, further comprising:
sending new data for the UE from the network controller to the target Node B, the new data not having been sent to the source Node B.

4. The method of claim 3, wherein the new data is sent after resending the portion of the data sent previously to the source Node B.

5. The method of claim 1, further comprising:
determining whether to buffer data for the UE at the network controller; and
continuously buffering a predetermined amount of latest data sent to a serving Node B for the UE if a decision is made to buffer the data for the UE.

6. The method of claim 1, further comprising:
determining whether to buffer a data flow for the UE; and
continuously buffering a predetermined amount of latest data for the data flow if a decision is made to buffer the data flow.

7. The method of claim 6, wherein the portion of the data sent previously to the source Node B is for the data flow and is resent to the target Node B if a decision is made to buffer the data flow.

8. The method of claim 1, further comprising:
maintaining at least one data flow for the UE;
determining whether to buffer each of the at least one data flow; and
resending to the target Node B a portion of data for each data flow in which a decision is made to buffer the data flow.

9. The method of claim 8, wherein the determining whether to buffer each of the at least one data flow comprises selecting each data flow carrying real-time data for buffering.

10. The method of claim 8, wherein the at least one data flow comprises at least one MAC-d flow.

11. The method of claim 1, wherein data is sent from at most one Node B to the UE at any given moment.

12. An apparatus for wireless communication, comprising:
at least one processor configured to send data for a user equipment (UE) from a network controller to a source Node B, to perform handover of the UE from the source Node B to a target Node B, and to resend from the network controller to the target Node B a portion of the data sent previously to the source Node B.

13. The apparatus of claim 12, wherein the at least one processor is configured to send new data for the UE from the network controller to the target Node B, the new data not having been sent to the source Node B.

14. The apparatus of claim 12, wherein the at least one processor is configured to determine whether to buffer data for the UE at the network controller, and to continuously buffer a predetermined amount of latest data sent to a serving Node B for the UE if a decision is made to buffer the data for the UE.

15. The apparatus of claim 12, wherein the at least one processor is configured to maintain at least one data flow for the UE, to determine whether to buffer each of the at least one data flow, and to resend to the target Node B a portion of data for each data flow in which a decision is made to buffer the data flow.

16. An apparatus for wireless communication, comprising:
means for sending data for a user equipment (UE) from a network controller to a source Node B;
means for performing handover of the UE from the source Node B to a target Node B; and
means for resending from the network controller to the target Node B a portion of the data sent previously to the source Node B.

17. The apparatus of claim 16, further comprising:
means for sending new data for the UE from the network controller to the target Node B, the new data not having been sent to the source Node B.

18. The apparatus of claim 16, further comprising:
means for determining whether to buffer data for the UE at the network controller; and
means for continuously buffering a predetermined amount of latest data sent to a serving Node B for the UE if a decision is made to buffer the data for the UE.

19. The apparatus of claim 16, further comprising:
means for maintaining at least one data flow for the UE;
means for determining whether to buffer each of the at least one data flow; and
means for resending to the target Node B a portion of data for each data flow in which a decision is made to buffer the data flow.

20. A computer program product, comprising:
a computer-readable medium comprising:
code for causing at least one computer to send data for a user equipment (UE) from a network controller to a source Node B;
code for causing at least one computer to perform handover of the UE from the source Node B to a target Node B; and
code for causing the at least one computer to resend from the network controller to the target Node B a portion of the data sent previously to the source Node B.

21. The computer program product of claim 20, wherein the computer-readable medium further comprises:
code for causing the at least one computer to send new data for the UE from the network controller to the target Node B, the new data not having been sent to the source Node B.

22. The computer program product of claim 20, wherein the computer-readable medium further comprises:
code for causing the at least one computer to determine whether to buffer data for the UE at the network controller; and
code for causing the at least one computer to continuously buffer a predetermined amount of latest data sent to a serving Node B for the UE if a decision is made to buffer the data for the UE.

23. The computer program product of claim 20, wherein the computer-readable medium further comprises:
code for causing the at least one computer to maintain at least one data flow for the UE;
code for causing the at least one computer to determine whether to buffer each of the at least one data flow; and
code for causing the at least one computer to resend to the target Node B a portion of data for each data flow in which a decision is made to buffer the data flow.

24. A method of sending data from a target Node B in a wireless communication system, comprising:
receiving resent data from a network controller, the resent data having been sent previously from the network controller to a source Node B;
sending the resent data to a user equipment (UE);
receiving new data from the network controller, the new data not having been sent from the network controller to the source Node B; and
sending the new data to the UE.

25. The method of claim 24, further comprising:
sending the resent data and the new data on a high speed shared channel to the UE.

26. An apparatus for wireless communication, comprising:
at least one processor configured to receive resent data from a network controller, the resent data having been sent previously from the network controller to a source Node B, to send the resent data to a user equipment (UE), to receive new data from the network controller, the new data not having been sent from the network controller to the source Node B, and to send the new data to the UE.

27. The apparatus of claim 26, wherein the at least one processor is configured to send the resent data and the new data on a high speed shared channel to the UE.

28. A method of receiving data in a wireless communication system, comprising:
receiving data from a source Node B;
performing handover from the source Node B to a target Node B; and
receiving resent data and new data from the target Node B, the resent data comprising data sent from a network controller to the source Node B and resent from the network controller to the target Node B, the new data comprising data sent by the network controller to the target Node B but not to the source Node B.

29. The method of claim 28, further comprising:
detecting for duplicate data received from both the source and target Node Bs; and
retaining a single copy of the duplicate data.

30. The method of claim 28, wherein the resent data is for a data flow selected for buffering.

31. The method of claim 28, wherein the resent data is for a data flow carrying real-time data.

32. An apparatus for wireless communication, comprising:
at least one processor configured to receive data from a source Node B, to perform handover from the source Node B to a target Node B, and to receive resent data and new data from the target Node B, the resent data comprising data sent from a network controller to the source Node B and resent from the network controller to the target Node B, the new data comprising data sent by the network controller to the target Node B but not to the source Node B.

33. The apparatus of claim 32, wherein the at least one processor is configured to detect for duplicate data received from both the source and target Node Bs, and to retain a single copy of the duplicate data.
